(19) United States
(12) Patent Application Publication
(10) Pub. No.: US 2025/0183406 A1
(43) Pub. Date: Jun. 5, 2025

(54) LIQUID COOLING PLATE, BATTERY PACK AND LOWER CASE THEREFOR, AND ENERGY STORAGE SYSTEM

(71) Applicant: Eve Energy Storage Co., Ltd., Wuhan (CN)

(72) Inventors: Shuzhu MA, Wuhan (CN); Zhonghuai ZHU, Wuhan (CN); Hexin LI, Wuhan (CN); Muhong GONG, Wuhan (CN); Guijie LEI, Wuhan (CN); Yulang ZOU, Wuhan (CN); Bihuan XIANG, Wuhan (CN)

(73) Assignee: Eve Energy Storage Co., Ltd., Wuhan (CN)

(21) Appl. No.: 18/931,106

(22) Filed: Oct. 30, 2024

(30) Foreign Application Priority Data
Dec. 1, 2023 (CN) 202323291926.4
Mar. 29, 2024 (WO) PCT/CN2024/084758

(51) Int. Cl. H01M 10/6556; H01M 10/613; H01M 10/647; H01M 50/103

(52) U.S. Cl. CPC H01M 10/6556; H01M 10/613; H01M 10/647; H01M 50/103

(57) ABSTRACT

A liquid cooling plate, a battery pack and a lower case therefor, and an energy storage system are provided. A plurality of main liquid cooling flow channels and auxiliary liquid cooling flow channels are arranged in a liquid cooling plate of a lower case for a battery pack. An integrated design of the liquid cooling plate and the lower case for the battery pack is realized without the need for installing a separate liquid cooling plate, so that the space utilization rate and energy density of the battery pack is improved. Moreover, the auxiliary liquid cooling flow channels cooperates with the main liquid cooling flow channels, the heat exchange effect between the coolant and the battery cell is improved, and the temperature consistency among the battery cells is enhanced. Therefore, the technical problem of poor temperature consistency among the battery cells is alleviated.

### CROSS-REFERENCE TO RELATED DISCLOSURE

This application claims the benefit of priority of PCT Patent Application No. PCT/CN2024/084758 filed on Mar. 29, 2024 and of Chinese Patent Application No. 202323291926.4 filed on Dec. 1, 2023, the contents of which are incorporated by reference as if fully set forth herein in their entirety.

### TECHNICAL FIELD

The disclosure relates to the technical field of batteries, and in particular, to a liquid cooling plate, a battery pack and a lower case therefor, and an energy storage system.

### BACKGROUND

The temperature environment in a battery pack has a great influence on the reliability, life and performance of battery cells. Therefore, it is particularly important to maintain the temperature in the battery pack within a certain temperature range. Liquid cooling technology is an effective means for maintaining the temperature in the battery pack. In liquid cooling technology, heat generated by the battery cells is carried away through convective heat exchange between liquids, so that the temperature of the battery cells is reduced.

In the prior art, an individual liquid cooling plate is usually arranged in a case for the battery pack to cool down the battery cells, and the liquid cooling plate is mechanically fixed to the case for the battery pack. Most of the internal flow channels of the liquid cooling plate are of a U-shaped structure. Therefore, due to the significant temperature difference between the liquid at a liquid inlet port of the liquid cooling plate and the liquid at a liquid outlet port of the liquid cooling plate, temperature consistency among the battery cells is poor, and the service life of the battery cells is shortened.

### SUMMARY

The present disclosure provides a liquid cooling plate, a battery pack and a lower case therefor, and an energy storage system to solve the above technical problems.

According to a first aspect, embodiments of the present disclosure provide a liquid cooling plate, a main liquid cooling flow channel and an auxiliary liquid cooling flow channel being formed in the liquid cooling plate, wherein one end of the main liquid cooling flow channel and one end of the auxiliary liquid cooling flow channel are both in communication with a liquid inlet port of the liquid cooling plate, and another end of the auxiliary liquid cooling flow channel is in communication with a latter half of the main liquid cooling flow channel.

According to a second aspect, embodiments of the present disclosure provide a lower case for a battery pack, including a liquid cooling plate according to one of the above-mentioned embodiments and multiple side plates surrounding the liquid cooling plate, wherein the multiple side plates surround the liquid cooling plate to form an accommodation chamber.

According to a third aspect, embodiments of the present disclosure further provide a battery pack, including the lower case for a battery pack according to one of the above-mentioned embodiments.

According to a fourth aspect, embodiments of the present disclosure further provide an energy storage system, including the battery pack according to the above-mentioned embodiments.

The beneficial effects of the disclosure are as follows. According to the embodiments of the present disclosure, a main liquid cooling flow channel and an auxiliary liquid cooling flow channels are formed in a liquid cooling plate, one end of the main liquid cooling flow channel and one end of the auxiliary liquid cooling flow channel are both in communication with a liquid inlet port of the liquid cooling plate, and another end of the auxiliary liquid cooling flow channel is in communication with a latter half of the main liquid cooling flow channel, so that the auxiliary liquid cooling flow channels cooperates with the main liquid cooling flow channels, the heat exchange effect between the coolant and the battery cells is improved, and the temperature consistency among the battery cells is enhanced. Therefore, the technical problem of poor temperature consistency among the battery cells due to the significant temperature difference between the liquid at the liquid inlet port of the liquid cooling plate and the liquid at the liquid outlet port of the liquid cooling plate in the prior art is alleviated.

### BRIEF DESCRIPTION OF THE DRAWINGS

FIG. 1 is a schematic plan view of the structure of a liquid cooling plate according to the present disclosure.

FIG. 2 is a schematic sectional view of the structure taken along the direction A-A′ in FIG. 1.

FIG. 3 is a three-dimensional schematic diagram of the structure of a lower case for a battery pack according to the present disclosure.

FIG. 4 is an exploded schematic view of the structure of the lower case for the battery pack in FIG. 3.

FIG. 5 is a schematic top view of the structure of the lower case for the battery pack in FIG. 3.

FIG. 6 is a schematic bottom view of the structure of the lower case for the battery pack in FIG. 3.

FIG. 7 is a detailed diagram of the structure of a liquid inlet nozzle and a liquid outlet nozzle in FIG. 3.

### REFERENCE NUMERALS IN THE DRAWINGS

100, lower case for battery pack; 101, accommodation chamber;
10, liquid cooling plate; 11, upper chamber wall; 12, lower chamber wall; 13, left side chamber wall; 14, right side chamber wall; 15, front chamber wall; 16, rear chamber wall; 110, chamber structure; 111, first partition; 112, second partition; 113, third partition; 114, fourth partition; 115, fifth partition; 151, liquid inlet port; 152, liquid outlet port; 161, opening; 1131, connection portion; 1132, extension portion;
20, side plate; 21, left side plate; 22, right side plate; 23, front plate; 24, rear plate; 231, first window; 232, connector mounting plate; 241, second window;
30, frame beam; 31, left side frame beam; 32, right side frame beam; 33, front frame beam; 34, rear frame member; 311, lifting structure; 312, mounting and fixing sleeve; 313, through hole;
40, reinforcing beam;
51, liquid inlet nozzle; 52, liquid outlet nozzle; 53, liquid inlet connection block; 54, liquid outlet connection block; 511, first section; 512, second section; 513, turning section;
60, main liquid cooling flow channel; 60-1, first main flow channel group; 60-2, second main flow channel group; 61, main flow channel; 70, auxiliary liquid cooling flow channel; 71, first auxiliary flow channel; 72, second auxiliary flow channel; 601, sub-flow channel.

### DETAILED DESCRIPTION

In the description of this disclosure, unless otherwise expressly specified and limited, terms “connect”, “couple”, “fix” should be interpreted in a broader way. For example, it can be a fixed connection, a detachable connection, or an integrated form. It can be a mechanical connection, or an electrical connection. It can be a direct connection, an indirect connection through an intermediate medium, a communication within two components, or an interaction between two components. For persons skilled in the art, the specific meaning of the above terms in this disclosure may be understood on a case-by-case basis.

In this disclosure, unless otherwise expressly specified and limited, a first feature being “on” or “below” a second feature may indicate a direct contact between the first and second features, or an indirect contact between the first and second features which are connected by another feature therebetween. Furthermore, the first feature being “on”, “above” or “over” the second feature indicates that the first feature is directly above or diagonally above the second feature, or simply indicates that the first feature is at a higher level than the second feature. The first feature being “below”, “under”, and “underneath” the second feature indicates that the first feature is directly below or diagonally below the second feature, or simply indicates that the first feature is at a lower level than the second feature.

In the description of the embodiments, orientation or position relationship indicated by terms “up”, “down”, “right” is based on the orientation or position relationship shown in the attached drawings, only for the purpose of facilitating description and simplifying operations, but not indicating or implying that the device or element referred to must have a particular orientation, or is constructed and operated in the particular orientation. Therefore, the orientation or position relationship is not limited thereto. In addition, terms “first” and “second” are used only to literally distinguish in terms of description and have no special meanings.

For the problem of poor temperature consistency among the battery cells in the battery pack in the prior art, the inventors of the present application found in the research that this is mainly because the internal flow channels of the liquid cooling plate in the battery pack are mostly in a U-shaped structure, resulting in significant temperature difference between the liquid at a liquid inlet port of the liquid cooling plate and the liquid temperature at a liquid outlet port of the liquid cooling plate, and leading to poor temperature consistency among the battery cells. In addition, with the continuous development of the electrochemical energy storage industry, there is an increasingly high requirement for area energy density of energy storage power stations. Various new battery packs and battery energy storage systems have emerged in the market. For example, compared to a small-sized battery pack, the size of the battery pack is getting larger, but the control over the temperature difference among the battery cells is worse.

Therefore, a liquid cooling plate, a battery pack and a lower case therefor, and an energy storage system are provided in the present disclosure to solve the above problems, wherein the liquid cooling plate is configured to dissipate heat from the battery cells in the battery pack.

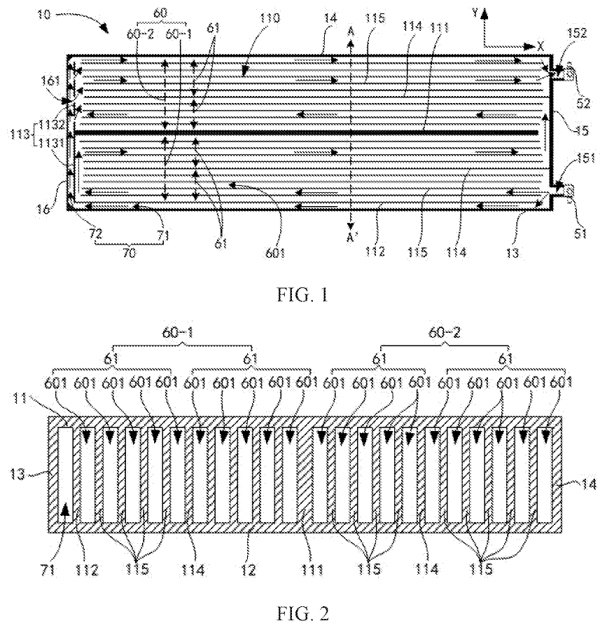

Referring to FIG. 1 and FIG. 2, FIG. 1 is a schematic plan view of the structure of a liquid cooling plate according to the present disclosure, and FIG. 2 is a schematic sectional view of the structure taken along the direction A-A′ in FIG. 1. A main liquid cooling flow channel 60 and an auxiliary liquid cooling flow channel 70 are formed in a liquid cooling plate 10. A liquid inlet port 151 and a liquid outlet port 152 are arranged on the liquid cooling plate 10. One end of the main liquid cooling flow channel 60 and one end of the auxiliary liquid cooling flow channel 70 are both in communication with the liquid inlet port 151 of the liquid cooling plate 10, and another end of the auxiliary liquid cooling flow channel 70 is in communication with a latter half of the main liquid cooling flow channel 60. The latter half of the main liquid cooling flow channel 60 is located at ½ to 9/10 of the total length of the main liquid cooling flow channel 60. For example, the latter half may be located at ½, ⅔, ¾, ⅗, ⅘, ⅚, 4/7, 5/7, 6/7, ⅝, ⅞, 5/9, 6/9, 7/9, 8/9, 7/10, 9/10, or the like of the total length of the main liquid cooling flow channel 60.

Specifically, the main liquid cooling flow channel 60 includes multiple main flow channels 61 extending along a first direction X. The multiple main flow channels 61 are arranged at intervals along a second direction Y, and two adjacent main flow channels 61 are in communication with each other. The first direction X is different from the second direction Y. For example, the first direction X is a length direction of the liquid cooling plate 10, the second direction Y is a width direction of the liquid cooling plate 10, and the length of the liquid cooling plate 10 is larger than the width of the liquid cooling plate 10. The auxiliary liquid cooling flow channel 70 is located on a periphery of the main liquid cooling flow channel 60. The auxiliary liquid cooling flow channel 70 includes a first auxiliary flow channel 71 and a second auxiliary flow channel 72, and the first auxiliary flow channel 71 and the second auxiliary flow channel 72 are in communication with each other. The first auxiliary flow channel 71 extends along the first direction X, and the second auxiliary flow channel 72 extends along the second direction Y.

The main liquid cooling flow channel 60 further includes a first main flow channel group 60-1 and a second main flow channel group 60-2, and the first main flow channel group 60-1 and the second main flow channel group 60-2 are arranged adjacent to each other. The second main flow channel group 60-2 is located on a side, away from the first auxiliary flow channel 71, of the first main flow channel group 60-1. Both the first main flow channel group 60-1 and the second main flow channel group 60-2 include the multiple main flow channels 61. A liquid inlet end of the first main flow channel group 60-1 is in communication with the liquid inlet port 151, a liquid outlet end of the first main flow channel group 60-1 is in communication with a liquid inlet end of the second main flow channel group 60-2. A liquid outlet end of the second main flow channel group 60-2 is in communication with the liquid outlet port 152. A liquid inlet end of the first auxiliary flow channel 71 is in communication with the liquid inlet port 151, and a liquid outlet end of the first auxiliary flow channel 71 is in communication with a liquid inlet end of the second auxiliary flow channel 72. A liquid outlet end of the second auxiliary flow channel 72 is in communication with an end, away from the liquid outlet port 152, of the second main flow channel group 60-2. The liquid inlet port 151 is used as an access through which a coolant enters the liquid cooling plate 10, and the liquid outlet port 152 is used as an access through which the coolant flows out of the liquid cooling plate 10. The liquid inlet end of the main flow channels 61 and the auxiliary flow channel is similar to the liquid inlet port 151 and is used as an access through which the coolant flows into the liquid cooling plate 10, and the liquid outlet end of the main flow channels 61 and the auxiliary flow channel is similar to the liquid outlet port 152 and is used as an access through which the coolant flows out of the liquid cooling plate 10.

In this embodiment, the liquid outlet end of the second auxiliary flow channel 72 is in communication with the end, away from the liquid outlet port 152, of the second main flow channel group 60-2, heat exchange between the coolant in the auxiliary liquid cooling flow channel 70 and the coolant in the main liquid cooling flow channel 60 is occurred, so that the heat exchange effect between the coolant and the battery cells is improved, and the temperature consistency among the battery cells is enhanced. Therefore, the technical problem of poor temperature consistency among the battery cells due to the significate temperature difference between the liquid at the liquid inlet port of the liquid cooling plate and the liquid at the liquid outlet port of the liquid cooling plate in the prior art is alleviated.

Specifically, the liquid cooling plate 10 includes a chamber structure 110, and the main liquid cooling flow channel 60 and the auxiliary liquid cooling flow channel 70 are formed in the chamber structure 110. The liquid cooling plate 10 includes an upper chamber wall 11 and a lower chamber wall 12, as well as multiple side chamber walls connected between the upper and lower chamber walls 11 and 12, and the upper chamber wall 11 and the lower chamber wall 12 are arranged opposite to each other. The multiple side chamber walls are connected end-to-end and surround the upper chamber wall 11 and the lower chamber wall 12 to form the chamber structure 110. The multiple side chamber walls include a left side chamber wall 13 and a right side chamber wall 14, and a front chamber wall 15 and a rear chamber wall 16 connected between the left side chamber wall 13 and the right side chamber wall 14, and the left side chamber wall 13 and the right side chamber wall 14 are arranged opposite to each other. The liquid inlet port 151 and the liquid outlet port 152 are both formed on the front chamber wall 15. That is, the liquid inlet port 151 and the liquid outlet port 152 are located on the same side of the liquid cooling plate 10. That is, openings are formed on the front chamber wall 15, and no opening is formed in other chamber walls so as to seal the liquid cooling flow channels. Optionally, friction stir welding is used to connect the side chamber walls with the upper chamber wall 11 and/or the lower chamber wall 12 to improve the sealing reliability of the flow channels.

The liquid cooling plate 10 further includes a first partition 111, a second partition 112, and a third partition 113, and the first partition 111, the second partition 112, and the third partition 113 are arranged in the chamber structure 110. The first partition 111 extends along the first direction X and is located between the first main flow channel group 60-1 and the second main flow channel group 60-2. The second partition 112 extends along the first direction X and is located between the first main flow channel group 60-1 and the first auxiliary flow channel 71. The third partition 113 extends along the second direction Y and is located on a side, away from the liquid inlet port 151, of the first main flow channel group 60-1. The third partition 113 includes a connection portion 1131 connected between the first partition 111 and the second partition 112.

The third partition 113 further includes an extension portion 1132 extending along the second direction Y from an end, away from the second partition 112, of the connection portion 1131. The extension portion 1132 is located on a side, away from the liquid outlet port 152, of the second main flow channel group 60-2. Multiple openings 161 are formed on the extension portion 1132. The second auxiliary flow channel 72 is in communication with an end, away from the liquid outlet port 152, of the second main flow channel group 60-2 through the openings 161. The multiple openings 161 are uniformly arranged on the extension portion 1132. That is, the distance between every two adjacent openings 161 is equal, so that the heat exchange between the coolant in the auxiliary liquid cooling flow channel 70 and the coolant in the main liquid cooling flow channel 60 is uniform, thereby the heat exchange effect between the coolant and the battery cells is improved, and the temperature consistency among the battery cells is enhanced.

The first partition 111, the second partition 112 and the third partition 113 are each connected between the upper chamber wall 11 and the lower chamber wall 12. The second partition 112 is located between the first partition 111 and the left side chamber wall 13. The third partition 113 is located at an end, away from the front chamber wall 15, of the first partition 111 and is connected to the first partition 111. The first auxiliary flow channel 71 is formed between the second partition 112 and the left side chamber wall 13, and the second auxiliary flow channel 72 is formed between the third partition 113 and the rear chamber wall 16. The first main flow channel group 60-1 is formed between the first partition 111 and the second partition 112, and the second main flow channel group 60-2 is formed between the first partition 111 and the right side chamber wall 14. One end of the first partition 111 is connected to the third partition 113. A gap is formed between another end of the first partition 111 and the front chamber wall 15, and the liquid outlet end of the first main flow channel group 60-1 is in communication with the liquid inlet end of the second main flow channel group 60-2 through the gap.

The liquid cooling plate 10 further includes multiple fourth partitions 114, each of the fourth partitions extends along the first direction X, and is located between every two adjacent main flow channels 61. The fourth partitions 114 are connected between the upper chamber wall 11 and the lower chamber wall 12. The fourth partitions 114 in the first main flow channel group 60-1 are located between the first partition 111 and the second partition 112. That is, the main flow channels 61 in the first main flow channel group 60-1 are formed between the first partition 111 and the fourth partitions 114, as well as between the fourth partitions 114 and the second partition 112. The fourth partitions 114 in the second main flow channel group 60-2 are located between the first partition 111 and the right side chamber wall 14. That is, the main flow channels 61 in the second main flow channel group 60-2 are formed between the first partition 111 and the fourth partitions 114, as well as between the fourth partitions 114 and the right side chamber wall 14. The second partition 112 is located between the fourth partitions 114 and the left side chamber wall 13, and the third partition 113 is located between the fourth partitions 114 and the rear chamber wall 16.

M fourth partitions 114 are arranged in the first main flow channel group 60-1, N fourth partitions 114 are arranged in the second main flow channel group 60-2, M and N are both odd numbers greater than or equal to 1. As schematically shown in FIG. 1 and FIG. 2, one fourth partition 114 is arranged in the first main flow channel group 60-1, and one fourth partition 114 is arranged in the second main channel group 60-2. In one embodiment, the first partition 111 is located at the middle area of the liquid cooling plate 10. In this case, the number of the fourth partitions 114 in the first main flow channel group 60-1 may be equal to the number of the fourth partitions 114 in the second main channel 60-2, i.e., M=N. Moreover, in case that the first partition 111 is located at the middle area of the liquid cooling plate 10, the width of the first partition 111 along the second direction Y is greater than the width of each of the fourth partitions 114 along the second direction Y, so as to reinforce the structure of the liquid cooling plate 10 and improve the load-bearing capacity of the liquid cooling plate 10.

Among the M fourth partitions 114, one end of a P-th fourth partition 114 is connected to the front chamber wall 15, and a gap is formed between another end of the P-th fourth partition 114 and the third partition 113. A gap is formed between one end of a fourth partition 114 adjacent to the P-th fourth partition 114 and the front chamber wall 15, and another end of the fourth partition 114 adjacent to the P-th fourth partition 114 is connected to the third partition 113, where P is an odd number greater than or equal to 1, and PEM. Among the N fourth partitions 114, one end of a Q-th fourth partition 114 is connected to the front chamber wall 15, and a gap is formed between another end of the Q-th fourth partition 114 and the third partition 113. A gap is formed between one end of a fourth partition 114 adjacent to the Q-th fourth partition 114 and the front chamber wall 15, and another end of the fourth partition 114 adjacent to the Q-th fourth partition 114 is connected to the third partition 113, where Q is an odd number greater than or equal to 1, and Q≤N. As schematically shown in FIG. 1 and FIG. 2, one fourth partition 114 is arranged in each of the first main flow channel group 60-1 and the second main flow channel group 61. In this case, M=N=P=Q. Taking the first main flow channel group 60-1 as an example, the fourth partition 114 in the first main flow channel group 60-1 divides the first main flow channel group 60-1 into two main flow channels 61, and one end of the fourth partition 114 is connected to the front chamber wall 15, and a gap is formed between another end of the fourth partition 114 and the third partition 113. The two main flow channels 61 in the first main flow channel group 61 are in communication with each other through the gap.

Thus, the fourth partitions 114, in cooperation with the first partition 111, divides the main liquid cooling flow channel 60 in the chamber structure 110 into multiple main flow channels 61. The coolant enters the main liquid cooling flow channel 60 through the liquid inlet port 151, sequentially passes through the multiple main flow channels 61 in the main liquid cooling flow channel 60, and flows out from the liquid outlet port 152. The flow path of the coolant in the main liquid cooling flow channel 60 is in an S-shaped. That is, the flow path of the main liquid cooling flow channel 60 is in an S-shaped. As indicated by the flow direction of the coolant schematically shown in FIG. 1, the flow path of the coolant is represented by a straight line with an arrow, and the direction of the arrow is the flow direction of the coolant in the main liquid cooling flow channel 60, and the positions of various flow channels are indicated by the straight line with two arrows. Thus, compared to the conventional U-shaped flow channels, the flow path of the main liquid cooling flow channel 60 is arranged in an S-shaped, the heat exchange effect between the coolant and the battery cells is improved, and the temperature consistency among the battery cells is enhanced.

The liquid cooling plate 10 further includes multiple fifth partitions 115 arranged in each of the main flow channels 61. The fifth partitions 115 are connected between the upper chamber wall 11 and the lower chamber wall 12. The multiple fifth partitions 115 extend along the first direction X and are arranged at intervals along the second direction Y. A gap is formed between one end of each of the fifth partitions 115 and the front chamber wall 15, and a gap is formed between another end of each of the fifth partitions 115 and the rear chamber wall 16. The multiple fifth partitions 115 divide each of the main flow channels 61 into multiple sub-flow channels 601 to further improve the heat exchange effect between the coolant and the battery cells and further enhance the temperature consistency between the battery cells. Moreover, the arrangement of the multiple fifth partitions 115 can further improve the structural strength of the liquid cooling plate 10 and the load-bearing capacity of the liquid cooling plate 10. Optionally, the multiple sub-flow channels 601 are uniformly arranged, and the channel width of every two adjacent sub-flow channels 601 along the second direction Y is the equal.

In this embodiment, the main liquid cooling flow channel 60 and the auxiliary liquid cooling flow channel 70 are arranged in the chamber structure 110 of the liquid cooling plate 10, the auxiliary liquid cooling flow channel 70 is located at the periphery of the main liquid cooling flow channel 60, and the liquid outlet end of the auxiliary liquid cooling flow channel 70 is in communication with an end, away from the liquid outlet port 152, of the second main flow channel group 60-2 of the main liquid cooling flow channel 60. Therefore, the auxiliary liquid cooling flow channel 70 is located at the edge of the liquid cooling plate 10, and the number of the battery cells passing through the auxiliary liquid cooling flow channel is reduced. Moreover, the total length of the auxiliary liquid cooling flow channel 70 is smaller than the total length of the main liquid cooling flow channel 60, thus the temperature of the coolant in the auxiliary liquid cooling flow channel 70 is lower than the temperature of the coolant in the main liquid cooling flow channel 60. Thus, the heat-exchange between the coolant in the auxiliary liquid cooling flow channel 70 and the coolant in the main liquid cooling flow channel 60 is occurred at the openings 161 of the third partition 113, so that the heat exchange effect between the coolant and the battery cells is improved, and the temperature consistency among the electric cells is enhanced. Therefore, the technical problem of poor temperature consistency among the battery cells in the prior art due to the significant temperature difference between the liquid at the liquid inlet port of the liquid cooling plate and the liquid at the liquid outlet port of the liquid cooling plate is alleviated.

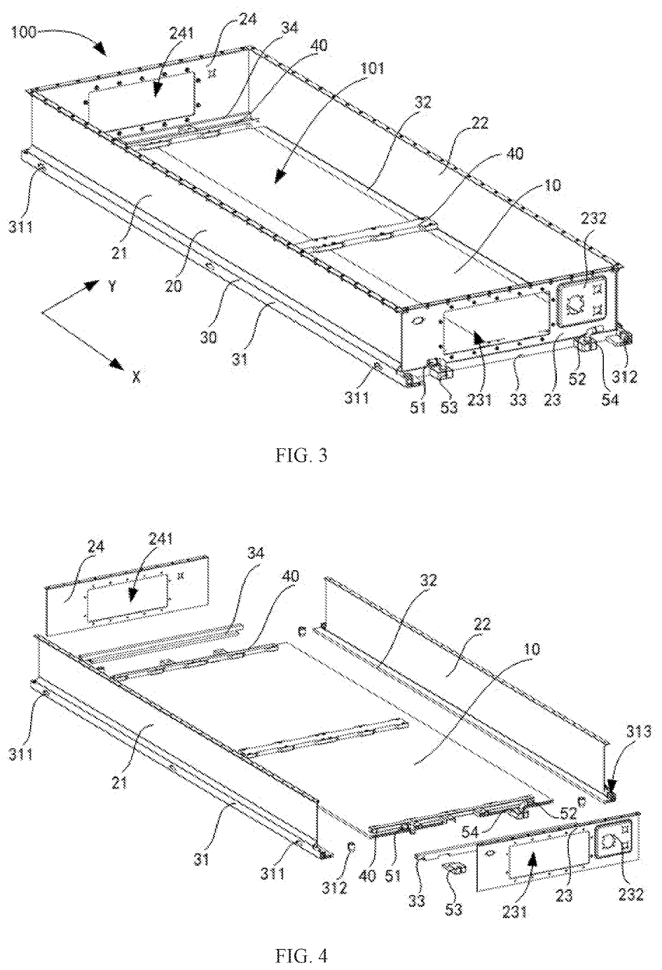

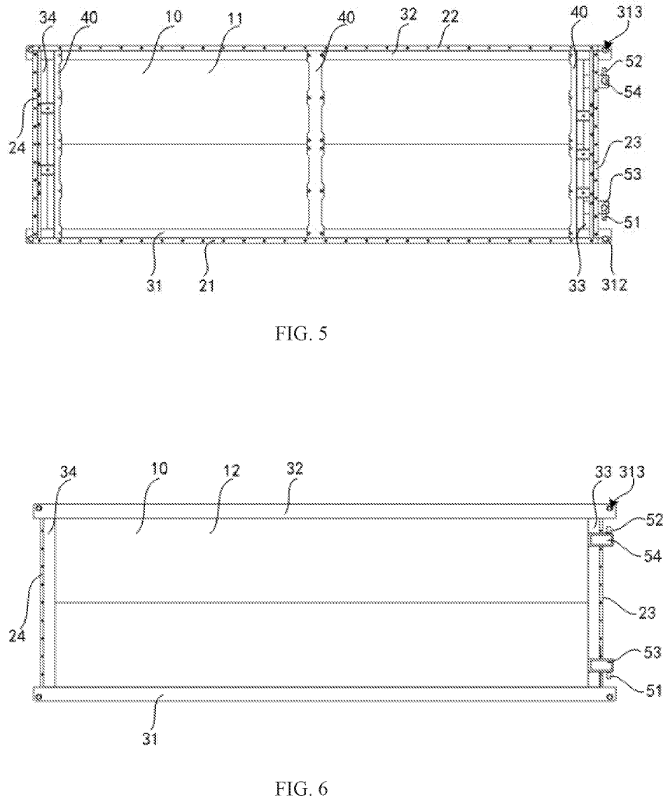

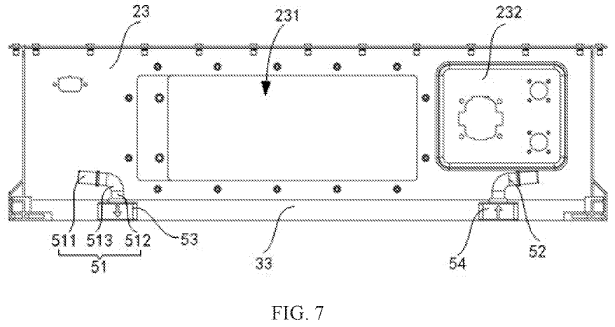

In one embodiment, the present disclosure further provides a lower case for a battery pack. Referring to FIG. 1 to FIG. 7, FIG. 3 is a three-dimensional schematic diagram of the structure of a lower case for a battery pack according to the present disclosure, FIG. 4 is an exploded schematic view of the structure of the lower case for the battery pack in FIG. 3, FIG. 5 is a schematic top view of the structure of the lower case for the battery pack in FIG. 3, FIG. 6 is a schematic bottom view of the structure of the lower case for the battery pack in FIG. 3, and FIG. 7 is a detailed diagram of the structure of the liquid inlet nozzle and the liquid outlet nozzle in FIG. 3. Referring to FIG. 3 and FIG. 4, a lower case 100 for a battery pack includes a liquid cooling plate 10 and multiple side plates 20 surrounding the liquid cooling plate 10. The multiple side plates 20 surround the liquid cooling plate 10 to form an accommodation chamber 101. The accommodation chamber 101 is configured for accommodating the battery cells. The liquid cooling plate includes the liquid cooling plate 10 according to one of the foregoing embodiments. Thus, the multiple main liquid cooling flow channels 60 and the auxiliary liquid cooling flow channel 70 are formed in the liquid cooling plate 10 of the lower case 100 for the battery pack, the liquid cooling plate 10 is designed to be integrated with the lower case 100 for the battery pack, without the need for installing a separate liquid cooling plate, so that the space utilization rate of the battery pack is improved, and the energy density of the battery pack is increased.

The side plates 20 include a left side plate 21 and a right side plate 22, as well as a front plate 23 and a rear plate 24. The left side plate 21 and the right side plate 22 are arranged opposite to each other, and the front plate 23 and the rear plate 24 are connected between the left side plate 21 and the right side plate 22. Both the left side plate 21 and the right side plate 22 extend along the first direction X, and both the front plate 23 and the rear plate 24 extend along the second direction Y.

A first window 231 is formed in the front plate 23, and a second window 241 is formed in the rear plate 24. The orthographic projection of the second window 241 on the front plate 23 overlaps with the first window 231. That is, the first window 231 is the same as the second window 241 in size. The first window 231 is formed by opening the front plate 23, and the second window 241 is formed by opening the rear plate 24. Both the first window 231 and the second window 241 are configured for maintenance of the battery pack.

A connector mounting plate 232 is further arranged on the front plate 23. The connector mounting plate 232 protrudes outwardly from the front plate 23, and is arranged to be integrated with the front plate 23. The connector mounting plate 232 is configured to mount a plate connector, such as a high voltage connector, or the like. Optionally, the connector mounting plate 232 is formed to be integrated with the front plate 23 by boss stamping process. Thus, the connector mounting plate 232 is formed by one-step molding without the need for secondary processing. Therefore, the consistency and high accuracy of the geometric size and surface quality of the connector mounting plate 232 are ensured, and the rigidity of the connector mounting plate 232 is enhanced, and the stability of the structure is improved.

The lower case 100 for the battery pack further includes frame beams 30 surrounding the liquid cooling plate 10. The side plates 20 are connected to the liquid cooling plate 10 through the corresponding frame beams 30. The frame beams 30 are configured to reinforce the structure of the lower case 100 for the battery pack. The frame beams 30 include a left side frame beam 31 and a right side frame beam 32, as well as a front frame beam 33 and a rear frame beam 34, the left side frame beam 31 and the right side frame beam 32 are arranged opposite to each other, and the front frame beam 33 and the rear frame beam 34 are connected between the left side frame beam 31 and the right side frame beam 32. The multiple side chamber walls of the liquid cooling plate 10 are respectively connected to the corresponding frame beams 30. For example, the left side chamber wall 13 is connected to the left side frame beam 31, the right side chamber wall 14 is connected to the right side frame beam 32, the front chamber wall 15 is connected to the front frame beam 33, and the rear chamber wall 16 is connected to the rear frame beams 34. Both the left side frame beam 31 and the right side frame beam 32 extend along the first direction X, and both the front frame beam 33 and the rear frame beam 34 extend along the second direction Y. The left side plate 21 is connected to the liquid cooling plate 10 through the left side frame beam 31, the right side plate 22 is connected to the liquid cooling plate 10 through the right side frame beam 32, the front plate 23 is connected to the liquid cooling plate 10 through the front frame beam 33, and the rear plate 24 is connected to the liquid cooling plate 10 through the rear frame beam 34.

The lower case 100 for the battery pack further includes multiple reinforcing beams 40 arranged on the liquid cooling plate 10 and located in the accommodation chamber 101. The reinforcing beams 40 are connected between the left side frame beam 31 and the right side frame beam 32. The reinforcing beams 40 are configured to reinforce the liquid cooling plate 10 so as to improve the load-bearing capacity of the liquid cooling plate 10 and enhance the overall strength of the lower case 100 for the battery pack. Therefore, more battery cells are loaded into the lower case 100 for the battery pack, and the battery pack in a larger size is achieved. The reinforcing beams 40 are uniformly arranged on the liquid cooling plate 10. The specific number of the reinforcing beams 40 can be determined according to the desired strength of the liquid cooling plate 10. For example, as schematically shown in FIG. 5, three reinforcing beams 40 are provided, two of three reinforcing beams 40 are arranged at both ends of the liquid cooling plate 10, and a third is arranged at the middle area of the liquid cooling plate 10. As to the reinforcing beams 40 that are arranged at both ends of the liquid cooling plate 10, one is close to the front plate 23, and another is close to the rear plate 24. Optionally, the lower case 100 for the battery pack can be formed by butt welding process of the aluminum extruded profiles of the liquid cooling plate 10, the side plates 20, the frame beams 30, and the reinforcing beams 40.

Optionally, the lower case 100 for the battery pack further includes multiple lifting structures 311 arranged on a side of the left side frame beam 31 and a side of the right side frame beam 32. The lifting structures 311 are configured for lifting the battery pack. Optionally, the lifting structures 311 may be formed as lifting holes arranged on the left side frame beam 31 and the right side frame beam 32. The cross-sectional of the lifting holes is in a convex shape, which is simple in structure and can improve the stability of lifting. Further, the lifting structures 311 are positioned corresponding to the reinforcing beams 40. That is, the lifting structures 311 are arranged at positions where the reinforcing beams 40 are connected to the left side frame beam 31 and the right side frame beam 32, so as to increase the load-bearing capacity of the lifting structures 311. The number of the lifting structures 311 arranged on the left side frame beam 31 and the right side frame beam 32 may be equal to the number of the reinforcing beams 40. For example, if the number of the reinforcing beams 40 is three, then the number of the lifting structures 311 on the left side frame beam 31 is three, and the number of the lifting structures 311 on the right side frame beam 32 is three.

The lower case 100 for the battery pack further includes multiple mounting and fixing sleeves 312 arranged on the left side frame beam 31 and the right side frame beam 32. The mounting and fixing sleeves are arranged at ends of the left side frame beam 31 and the right side frame beam 32, and are configured to fix the lower case 100 for the battery pack. For example, the lower case 100 for the battery pack can be fixed by inserting fixing bolts through the mounting and fixing sleeves 312. Specifically, referring to FIG. 5 and FIG. 6, one of two through holes 313 is close to the front frame beam 33, and another is close to the rear frame beam 34. The through-holes 313 extend through the corresponding left side frame beam 31 or the right side frame beams 32. Each of the mounting and fixing sleeves 312 is embedded in one of the through holes 313 and is fixedly connected to the left side frame beam 31 or the right side frame beam 32. For example, the mounting and fixing sleeves 312 can be fixedly connected to the left side frame beam 31 or the right side frame beam 32 by welding process. The structure strength of the mounting and fixing sleeves 312 is greater than the structure strength of the left side frame beam 31 and the structure strength of the right side frame beam 32, so that the overall mounting strength of the lower case 100 for the battery pack is improved, and the stability of mounting and fixing is enhanced. Furthermore, the mounting and fixing sleeves 312 are arranged at both ends of the left side frame beam 31 and the right side frame beam 32, the front and the rear ends of the lower case 100 for the battery pack can be fixed, thereby the reliability of the battery energy storage system during transportation with batteries is ensured.

Furthermore, the lower case 100 for the battery pack further includes a liquid inlet nozzle 51 and a liquid outlet nozzle 52, as well as a liquid inlet connection block 53 and a liquid outlet connection block 54, the liquid inlet connection block is connected to the liquid inlet nozzle 51, and the liquid outlet connection block is connected to the liquid outlet nozzle 52. The liquid inlet connection block 53 and the liquid outlet connection block 54 both passing through the front frame beam 33 and are connected to the liquid cooling plate 10. The liquid inlet nozzle 51 is in communication with the liquid inlet port of the liquid cooling plate 10 through the liquid inlet connection block 53. The liquid outlet nozzle 52 is in communication with the liquid outlet port of the liquid cooling plate 10 through the liquid outlet connection block 54.

Referring to FIG. 7, both the liquid inlet nozzle 51 and the liquid outlet nozzle 52 include first a section 511 and a second section 512, as well as a turning section 513 connected between the first section 511 and the second section 512. The first section 511 is in communication with the second section 512 through the turning section 513. A surface of the turning section 513 is in a curved shape. The first section 511 intersects with the second section 512 to form a first included angle. The first included angle is not equal to 90 degrees so as to avoid operational interference between the liquid inlet nozzle 51 and the liquid outlet nozzle 52 with the connector mounting plate and the fixing bolts.

In one embodiment, the present disclosure further provides a battery pack including the lower case 100 for the battery pack according to one of the foregoing embodiments. The battery pack further includes multiple battery cells accommodated in the accommodation chamber 101 of the lower case 100 for the battery pack, and a cover that cooperates with the side plates 20 of the lower case 100 for the battery pack to seal the battery pack.

In one embodiment, the present disclosure further provides an energy storage system including the battery pack according to the foregoing embodiments. The energy storage system further includes a battery rack and a battery cluster. The battery pack is mounted and fixed to the battery cluster, and the battery cluster is mounted and fixed to the battery rack.

The embodiments of this disclosure are explained in detail as stated above. In the context, specific examples are used to elaborate the principle and implementation of the disclosure. The description of the above embodiments is only used to help understand the method and cell ideas of this disclosure. At the same time, persons skilled in the art can modify the specific embodiments and applications according to the idea of this disclosure. In summary, the content of this specification should not be understood as a limitation on this application.

What is claimed is:

1. A liquid cooling plate (10), comprises a main liquid cooling flow channel (60) and an auxiliary liquid cooling flow channel (70),
wherein one end of the main liquid cooling flow channel (60) and one end of the auxiliary liquid cooling flow channel (70) are both in communication with a liquid inlet port (151) of the liquid cooling plate (10), and another end of the auxiliary liquid cooling flow channel (70) is in communication with a latter half of the main liquid cooling flow channel (60).

2. The liquid cooling plate (10) according to claim 1, wherein, the latter half of the main liquid cooling flow channel (60) is located at ½ to 9/10 of a total length of the main liquid cooling flow channel (60).

3. The liquid cooling plate (10) according to claim 2, wherein, the main liquid cooling flow channel (60) comprises a plurality of main flow channels (61) extending along a first direction, the plurality of main flow channels (61) are arranged at intervals along a second direction, the first direction is different from the second direction, and every two adjacent main flow channels (61) are in communication with each other;
the auxiliary liquid cooling flow channel (70) is located on a periphery of the main liquid cooling flow channel (60), the auxiliary liquid cooling flow channel (70) comprises a first auxiliary flow channel (71) and a second auxiliary flow channel (72), and the first auxiliary flow channel (71) and the second auxiliary flow channel (72) are in communication with each other, the first auxiliary flow channel (71) extends along the first direction, and the second auxiliary flow channel (72) extends along the second direction;
wherein, a liquid outlet port (152) is arranged on the liquid cooling plate (10), the main liquid cooling flow channel (60) further comprises a first main flow channel group (60-1) and a second main flow channel group (60-2), the first main flow channel group (60-1) and the second main flow channel group (60-2) are arranged adjacent to each other, the second main flow channel group (60-2) is located at a side, away from the first auxiliary flow channel (71), of the first main flow channel group (60-1), both the first main flow channel group (60-1) and the second main flow channel group (60-2) comprise the plurality of main flow channels (61), a liquid inlet end of the first main flow channel group (60-1) is in communication with the liquid inlet port (151), a liquid outlet end of the first main flow channel group (60-1) is in communication with a liquid inlet end of the second main flow channel group (60-2), a liquid outlet end of the second main flow channel group (60-2) is in communication with the liquid outlet port (152), a liquid inlet end of the first auxiliary flow channel (71) is in communication with the liquid inlet port (151), a liquid outlet end of the first auxiliary flow channel (71) is in communication with a liquid inlet end of the second auxiliary flow channel (72), a liquid outlet end of the second auxiliary flow channel (72) is in communication with a end, away from the liquid outlet port (152), of the second main flow channel group (60-2).

4. The liquid cooling plate (10) according to claim 3, the liquid cooling plate (10) further comprises a first partition (111), a second partition (112), and a third partition (113),
wherein the first partition (111) extends along the first direction and is located between the first main flow channel group (60-1) and the second main flow channel group (60-2); the second partition (112) extends along the first direction and is located between the first main flow channel group (60-1) and the first auxiliary flow channel (71); the third partition (113) extends along the second direction and is located on a side, away from the liquid inlet port (151), of the first main flow channel group (60-1), and the third partition (113) comprises a connection portion (1131) connected between the first partition (111) and the second partition (112).

5. The liquid cooling plate (10) according to claim 4, wherein the third partition (113) further comprises an extension portion (1132) extending along the second direction from an end, away from the second partition (112), of the connection portion (1131), the extension portion (1132) is located on a side, away from the liquid outlet port (152), of the second main flow channel group (60-2), a plurality of openings (161) are formed on the extension portion (1132), and the second auxiliary flow channel (72) is in communication with the second main flow channel group (60-2) through the openings (161).

6. The liquid cooling plate (10) according to claim 5, wherein the liquid cooling plate (10) further comprises a plurality of fourth partitions (114), each of the fourth partitions extends along the first direction and is located between every two adjacent main flow channels (61), wherein M fourth partitions (114) are arranged in the first main flow channel group (60-1) and N fourth partitions (114) are arranged in the second main flow channel group (60-2), and both M and N are odd numbers greater than or equal to 1.

7. The liquid cooling plate (10) according to claim 6, where the first partition (111) is located at a middle area of the liquid cooling plate (10), and a width of the first partition (111) in the second direction is greater than a width of each of the fourth partitions (114) in the second direction.

8. The liquid cooling plate (10) according to claim 6, wherein the liquid cooling plate (10) further comprises an upper chamber wall (11) and a lower chamber wall (12), as well as a left side chamber wall (13), a right side chamber wall (14), a front chamber wall (15), and a rear chamber wall (16), the upper chamber wall (11) and the lower chamber wall (12) are arranged opposite to each other, and the right side chamber wall (14), the front chamber wall (15), and the rear chamber wall (16) are connected between the upper chamber wall (11) and the lower chamber wall (12) and surround the upper chamber wall (11) and the lower chamber wall (12);
the left side chamber wall (13) and the right side chamber wall (14) are arranged opposite to each other, the front chamber wall (15) and the rear chamber wall (16) both are connected between the left side chamber wall (13) and the right side chamber wall (14), and the liquid inlet port (151) and the liquid outlet port (152) both are located on the front chamber wall (15);
the first partition (111), the second partition (112), the third partition (113), and the fourth partitions (114) are connected between the upper chamber wall (11) and the lower chamber wall (12), the fourth partitions (114) are located between the first partition (111) and the second partition (112), the second partition (112) is located between the fourth partitions (114) and the left side chamber wall (13), and the third partition (113) is located between the fourth partitions (114) and the rear chamber wall (16);
one end of the first partition (111) is connected with the third partition (113), and a gap is formed between another end of the first partition (111) and the front chamber wall (15); one end of a P-th fourth partition (114) among the M fourth partitions is connected with the front chamber wall (15), and a gap is formed between another end of the P-th fourth partition (114) and the third partition (113); a gap is formed between one end of a fourth partition (114) adjacent to the P-th fourth partition (114) and the front chamber wall (15), and another end of the fourth partition (114) adjacent to the P-th fourth partition (114) is connected with the third partition (113); where P is an odd number greater than or equal to 1, and PEM; one end of a Q-th fourth partition (114) among the N fourth partitions is connected with the front chamber wall (15), and a gap is formed between another end of the Q-th fourth partition (114) and the third partition (113); a gap is formed between one end of a fourth partition (114) adjacent to the Q-th fourth partition (114) and the front chamber wall (15), and another end of the fourth partition (114) adjacent to the Q-th fourth partition (114) is connected with the third partition (113); where Q is an odd number greater than or equal to 1, and Q≤N.

9. The liquid cooling plate (10) according to claim 8, wherein the liquid cooling plate (10) further comprises a plurality of fifth partitions (115) arranged in each of the main flow channels (61), the plurality of fifth partitions (115) extend along the first direction and are arranged at intervals along the second direction, and the plurality of fifth partitions (115) divide each of the main flow channels (61) into a plurality of sub-flow channels (601); a gap is formed between one end of each of the fifth partitions (115) and the front chamber wall (15), and a gap is formed between another end of each of the fifth partitions (115) and the rear chamber wall (16).

10. The liquid cooling plate (10) according to claim 8, wherein the left side chamber wall (13), the right side chamber wall (14), the front chamber wall (15) and the rear chamber wall (16) are connected end-to-end and surround the upper chamber wall (11) and the lower chamber wall (12) to form a chamber structure (110), the main liquid cooling flow channel (60) and the auxiliary liquid cooling flow channel (70) are formed in the chamber structure (110).

11. A lower case (100) for a battery pack, comprising a liquid cooling plate (10) and a plurality of side plates (20) surrounding the liquid cooling plate (10),
wherein liquid cooling plate (10) comprises a main liquid cooling flow channel (60) and an auxiliary liquid cooling flow channel (70), one end of the main liquid cooling flow channel (60) and one end of the auxiliary liquid cooling flow channel (70) are both in communication with a liquid inlet port (151) of the liquid cooling plate (10), and another end of the auxiliary liquid cooling flow channel (70) is in communication with a latter half of the main liquid cooling flow channel (60); and
wherein the plurality of side plates (20) surround the liquid cooling plate (10) to form an accommodation chamber (101).

12. The lower case (100) for a battery pack according to claim 11, wherein the side plates (20) comprise a left side plate (21) and a right side plate (22) that are arranged opposite to each other, as well as a front plate (23) and a rear plate (24) that are connected between the left side plate (21) and the right side plate (22), both the left side plate (21) and the right side plate (22) extend along the first direction, and both the front plate (23) and the rear plate (24) extend along the second direction;
the lower case (100) for a battery pack further comprises a left side frame beam (31) and a right side frame beam (32), as well as a front frame beam (33) and a rear frame beam (34), the left side frame beam (31) and the right side frame beam (32) are arranged opposite to each other, and the front frame beam (33) and the rear frame beam (34) are connected between the left side frame beam (31) and the right side frame beam (32);
the left side plate (21) is connected to the liquid cooling plate (10) through the left side frame beam (31), the right side plate (22) is connected to the liquid cooling plate (10) through the right side frame beam (32), the front plate (23) is connected to the liquid cooling plate (10) through the front frame beam (33), and the rear plate (24) is connected to the liquid cooling plate (10) through the rear frame beam (34).

13. The lower case (100) for a battery pack according to claim 12, wherein the lower case (100) for a battery pack further comprises a plurality of reinforcing beams (40) arranged on the liquid cooling plate (10) and located in the accommodation chamber (101), and the reinforcing beams (40) are connected between the left side frame beam (31) and the right side frame beam (32);
a plurality of lifting structures (311) are arranged on a side of the left side frame beam (31) and a side of the right side frame beam (32), and the lifting structures (311) are positioned corresponding to the strengthening beams (40).

14. The lower case (100) for a battery pack according to claim 12, wherein at least two through holes (313) are arranged on each of the left side frame beam (31) and the right side frame beam (32), one of the two through holes (313) is close to the front frame beam (33) and another of the two through holes (313) is close to the rear frame beam (34);
the lower case (100) for a battery case further comprises a plurality of mounting and fixing sleeves (312), each of the mounting and fixing sleeves is embedded in one of the through holes (313) and is fixed to the left side frame beam (31) or the right side frame beam (32).

15. The lower case (100) for a battery pack according to claim 12, wherein the lower body (100) for a battery pack further comprises a liquid inlet nozzle (51) and a liquid outlet nozzle (52), as well as a liquid inlet connection block (53) and a liquid outlet connection block (54), the liquid inlet connection block (53) is connected to the liquid inlet nozzle (51), and the liquid outlet connection block (54) is connected to the liquid outlet nozzle (52), both the liquid inlet connection block (53) and the liquid outlet connection block (54) are connected with the liquid cooling plate (10) through the front frame beam (33), and the liquid inlet nozzle (51) is in communication with the liquid inlet port (151) on the liquid cooling plate (10) through the liquid inlet connection block (53), the liquid outlet nozzle (52) is in communication with the liquid outlet port (152) on the liquid cooling plate (10) through the liquid outlet connection block (54).

16. The lower case (100) for a battery pack according to claim 15, wherein both the liquid inlet nozzle (51) and the liquid outlet nozzle (52) include a first section (511), a second section (512), and a turning section (513) connected between the first section (511) and the second section (512), the first section (511) is in communication with the second section (512) through the turning section (513), a surface of the turning section (513) is in a curved shape, the first section (511) intersects with the second section (512) to form a first angle, and the first angle is not equal to 90 degrees.

17. The lower case (100) for a battery pack according to claim 12, wherein a first window (231) is formed in the front plate (23), a second window (241) is formed in the rear plate (24), and an orthographic projection of the second window (241) on the front plate (23) overlaps with the first window (231).

18. The lower case (100) for a battery pack according to claim 12, wherein a connector mounting plate (232) is further arranged on the front plate (23), the connector mounting plate (232) protrudes outwardly from the front plate (23), and the connector mounting plate (232) is formed to be integrated with the front plate (23).

19. A battery pack, comprising the lower case (100) for the battery pack,
wherein the lower case (100) for a battery pack comprises a liquid cooling plate (10) and a plurality of side plates (20) surrounding the liquid cooling plate (10),
wherein liquid cooling plate (10) comprises a main liquid cooling flow channel (60) and an auxiliary liquid cooling flow channel (70), one end of the main liquid cooling flow channel (60) and one end of the auxiliary liquid cooling flow channel (70) are both in communication with a liquid inlet port (151) of the liquid cooling plate (10), and another end of the auxiliary liquid cooling flow channel (70) is in communication with a latter half of the main liquid cooling flow channel (60); and
wherein the plurality of side plates (20) surround the liquid cooling plate (10) to form an accommodation chamber (101).

20. An energy storage system, comprising the battery pack according to claim 19.
